(19) United States
(12) Patent Application Publication
(10) Pub. No.: US 2014/0215586 A1
(43) Pub. Date: Jul. 31, 2014

(54) METHODS AND SYSTEMS FOR GENERATING AND USING A DERIVED AUTHENTICATION CREDENTIAL

(71) Applicant: Catherine Jo TILTON, Winchester, VA (US)

(72) Inventor: Catherine Jo TILTON, Winchester, VA (US)

(21) Appl. No.: 13/755,514

(22) Filed: Jan. 31, 2013

(51) Int. Cl. G06F 21/31; G06F 21/45

(52) U.S. Cl. CPC G06F 21/31; G06F 21/45
USPC 726/6; 726/7

(57) ABSTRACT

A method for generating a derived authentication credential includes determining whether a first authentication credential obtained from an individual is valid. The first authentication credential includes device data. Moreover, the method includes verifying the individual is a first authentication credential legitimate user after the first authentication credential is validated, and determining that a second authentication credential associated with the individual is valid after the individual is determined to be the legitimate user. Furthermore, the method includes capturing authentication data from the individual with a communications device, and after successfully authenticating the individual with an authentication computer system with the captured authentication data, combining the second authentication credential with the device data.

### BACKGROUND OF THE INVENTION

This invention relates generally to authentication credentials, and more particularly, to methods and systems for generating a derived authentication credential and using the derived authentication credential in authentication transactions.

Individuals typically store confidential data on, and conduct confidential communications over the Internet through, computers. Imposters have been known to obtain access to such confidential data and communications by surreptitiously obtaining and using data for accessing the computer, and by eavesdropping on communications conducted by individuals over the Internet. To counter such imposter activities, individuals are typically required to successfully authenticate their identity through any one of various techniques prior to gaining access to a computer and its data. For example, smart card security techniques have been adopted by many companies and governmental agencies to protect sensitive data, information, and confidential communications against imposters.

Smart card security techniques generally involve fitting a computer or computer system with a smart card reader, or readers, that communicate with the computer and process data on a smart card to conduct smart card transactions. Smart card transactions typically include at least authenticating smart card holders, encrypting and decrypting data, and creating digital signatures. Smart cards typically include authentication data of an authorized individual and are generally assigned to and used by individuals authorized to use a computer or computer system. As part of accessing the computer or computer system, authorized individuals are authenticated by inserting their smart card into the smart card reader such that the smart card may participate in an authentication transaction using the security data stored thereon and authentication data obtained from the individual. Upon successful authentication, the individual is permitted to access the computer or computer system.

However, producing, distributing, and installing smart card readers and smart cards have been known to be expensive. Moreover, imposters have been known to surreptitiously steal smart cards from authorized individuals and to use the stolen cards to gain unauthorized access to confidential data, to eavesdrop on confidential communications, and to otherwise conduct fraudulent network-based transactions. Furthermore, there are computing devices, for example, tablets, incapable of accommodating smart card use. Additionally, individuals may not always possess their smart card for various reasons including personal safety.

### BRIEF DESCRIPTION OF THE INVENTION

In one aspect, a method for generating a derived authentication credential is provided that includes determining whether a first authentication credential obtained from an individual is valid. The first authentication credential includes device data. Moreover, the method includes verifying the individual is a first authentication credential legitimate user after the first authentication credential is validated, and determining that a second authentication credential associated with the individual is valid after the individual is determined to be the legitimate user. Furthermore, the method includes capturing authentication data from the individual with a communications device, and after successfully authenticating the individual with an authentication computer system with the captured authentication data, combining the second authentication credential with the device data.

In another aspect, a system for generating a derived authentication credential is provided that includes a communications device configured to capture authentication data. The device is associated with an individual. Moreover, the system includes a computer positioned at an authentication station. The computer is configured to determine whether a first authentication credential obtained from an individual has not expired and that data included in the first authentication credential has not been changed. The first authentication credential includes device data. Furthermore, the system includes a credential validation system configured to validate the digital certificate and an authentication system.

The authentication system includes an authentication database. The authentication system, the credential validation system, the computer and the communications device are configured to communicate with each other over a network. The authentication system is further configured to verify the individual is a first authentication credential legitimate user, and to combine a second authentication credential associated with the individual with the device data after verifying the individual is a legitimate user and successfully authenticating the individual.

In yet another aspect, a method for conducting an authentication transaction using a derived authentication credential is provided that includes determining whether a derived authentication credential for an individual is valid with an authentication computer system. The derived authentication credential includes an enrollment data record for the individual and binding data. The binding data is from a different authentication credential assigned to the individual. Moreover, the method includes authenticating the individual with the derived authentication credential when the derived authentication credential is valid, and after successfully authenticating the individual determining whether the different authentication credential is valid with a credential validation system. Furthermore, the method includes conducting a desired transaction when the different authentication credential is valid.

### BRIEF DESCRIPTION OF THE DRAWINGS

FIG. 1 is a diagram of an exemplary embodiment of a security system for generating and using derived authentication credentials;

FIG. 2 is a diagram illustrating exemplary data that may be stored in an authentication credential;

FIG. 3 is another diagram illustrating exemplary data that may be stored in an authentication credential;

FIG. 4 is yet another diagram illustrating exemplary data that may be stored in a derived authentication credential;

FIG. 5 is a flowchart illustrating an exemplary process for generating derived authentication credentials for individuals enrolled in an Authentication Computer (AC) system;

FIG. 6 is a flowchart illustrating an exemplary process for generating derived authentication credentials for individuals not enrolled in the AC system; and

FIG. 7 is a flowchart illustrating an exemplary process for conducting authentication transactions with derived authentication credentials.

### DETAILED DESCRIPTION OF THE INVENTION

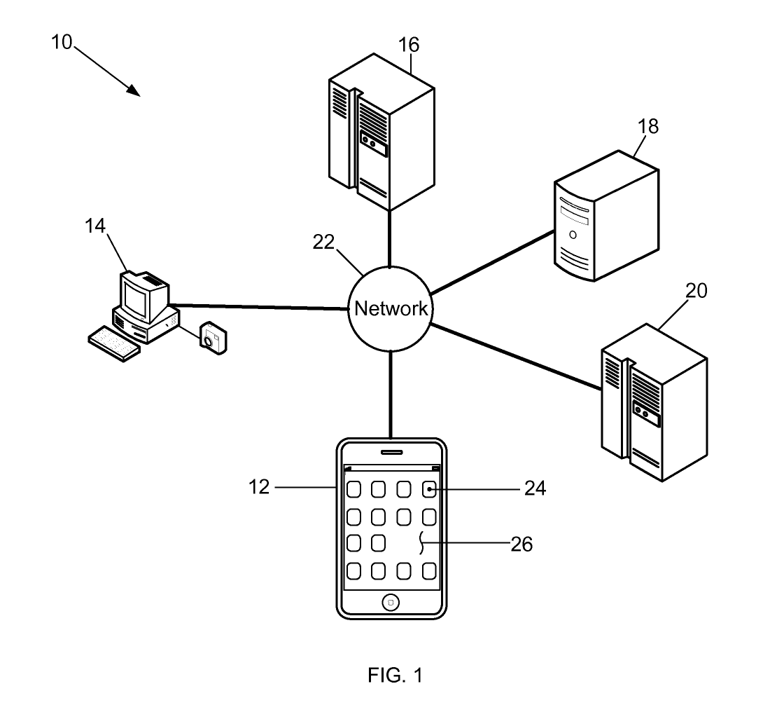

FIG. 1 is a diagram of an exemplary embodiment of a security system 10 for generating and using derived authentication credentials. More specifically, the security system 10 includes a communications device 12, an authentication station computer 14, an authentication computer (AC) system 16, a credential validation server (CVS) system 18, and a merchant system 20 configured to communicate with each other over a network 22 and with other systems (not shown) and devices (not shown). Other systems (not shown) include computer systems of service providers such as, but not limited to, financial institutions, medical facilities, and governmental agencies. Other systems (not shown) may also include computer systems associated with merchants different than the merchant associated with the merchant system 20. Operators of the merchant system 20 and of these other systems (not shown) may rely on the AC system 16 to authenticate the identities of individuals requesting to conduct a transaction with the merchant system 20 and the other systems (not shown). Other devices (not shown) include, but are not limited to, smart phones, tablet computers, lap top computers, and personal computers.

The communications network 22 is a 4G communications network. Alternatively, the communications network 22 may be any wireless network including, but not limited to, 3G, Wi-Fi, Global System for Mobile (GSM), Enhanced Data for GSM Evolution (EDGE), and any combination of a local area network (LAN), a wide area network (WAN) and the Internet. The network 22 may also be any type of wired network.

The communications device 12 is a smart phone that at least stores data and applications therein, executes applications, displays text and images, and captures authentication data from individuals. The communications device 12 includes buttons or icons 24 for entering commands and invoking applications stored therein, and a display screen 26 such as, but not limited to, a Liquid Crystal Display (LCD) that displays text and images and may be touch sensitive. Moreover, the communications device 12 may include cameras (not shown), a microphone (not shown), and other biometric capture devices (not shown). For example, such other biometric capture devices (not shown) include, but are not limited to, an embedded fingerprint scanner. The communications device 12 may store any data therein and may be associated with an individual.

Although the communications device 12 is a smart phone in the exemplary security system 10, the communications device 12 may alternatively be any device capable of at least storing data, displaying at least one of text and images, communicating over the network 22, conducting any type of network-based transaction over the network 22 with other systems (not shown), and capturing and transmitting data. Such other devices include, but are not limited to, a portable cellular phone, a tablet computer, a laptop computer, a personal computer equipped with a web camera and other types of biometric data capture devices and scanners, any type of portable communications device having wireless capabilities such as a personal digital assistant (PDA), entertainment devices and gaming consoles. Entertainment devices include, but are not limited to, televisions. Gaming consoles include, but are not limited to, Xbox 360 and Nintendo Wii.

The communications device 12 may be used to capture authentication data from individuals and transmit the captured authentication data to the AC system 16. Alternatively, the communications device 12 may process the captured authentication data prior to transmitting it to the AC system 16. For example, the communications device 12 may capture biometric data, create a biometric template from the captured data, and then transmit the biometric template to the AC system 16. Although the exemplary security system 10 includes one communications device 12, the security system 10 may alternatively include any number of communications devices 12 that are each associated with a same or different individual.

The authentication station computer 14 is a personal computer that includes devices such as, but not limited to, a CD-ROM drive for reading data from computer-readable recording mediums, such as a compact disc-read only memory (CD-ROM), and a digital versatile disc (DVD). Moreover, the computer 14 includes a display device such as, but not limited to, a liquid crystal display (LCD), a cathode ray tube (CRT) and other display monitors. Furthermore, the authentication station computer 14 may include a printer and input devices such as, but not limited to, a mouse (not shown), keypad (not shown), a keyboard, a camera, a microphone (not shown), a smart card reader (not shown), and any type of biometric capture device (not shown). The computer 14 is configured to communicate over the network 22, store applications, and may be used to capture authentication data.

Although the computer 14 is a personal computer in the exemplary security system 10, the computer 14 may alternatively be any computing device capable of capturing authentication data from individuals. Such devices include, but are not limited to, tablet computers, smart phones, laptop computers, and any type of communications device having wireless capabilities such as a personal digital assistant (PDA). The authentication station computer 14 is located at an authentication station and may be operated by security personnel of an authentication entity to authenticate identities of individuals and to facilitate enrolling individuals in the AC system 16. Although the exemplary security system 10 includes one authentication station computer 14, the security system 10 may alternatively include any number of computers 14 located at corresponding authentication stations.

It should be understood that the communications device 12 may store the same information, and perform the same functions, as the authentication station computer 14. Thus, the communications device 12 may be substituted for the authentication station computer 14 to perform the same functions described herein for the authentication station computer 14.

The AC system 16 includes components such as, but not limited to, a web server, a database server, an application server, a directory server and a disk storage unit that may be used to store any kind of data. The disk storage unit may store at least one database such as, but not limited to, an authentication database. The application server stores applications therein that cause the AC system 16 to perform the functions described herein. The AC system 16 also includes a database management server and an authentication server. The database management server may be used to facilitate transferring data to and from the disk storage device. The authentication server performs matching of any feature or information associated with individuals to verify identities of such individuals during authentication transactions.

The AC system 16 may also store configurable authentication policies, some of which may be used to determine data that is to be captured or obtained from individuals during enrolment in the AC system 16, and others which may be used to determine an authentication data requirement. The authentication data requirement is the authentication data to be captured from individuals during authentication transactions. The authentication data requirement may be any type of authentication data, or any combination of different types of authentication data and may be determined in any manner by the AC system 16.

The authentication database stores at least authentication data of each of a plurality of individuals in enrollment data records. Authentication data may be any kind of information that may be used to authenticate individuals such as, but not limited to, private pass-phrases, personal identification numbers (PIN), cryptographic data, geolocation coordinates, biometric data, and any combination thereof. Biometric data may correspond to any biometric characteristic desired to be used as a basis of authentication such as, but not limited to, voice, face, finger, iris, palm, signature, vascular, and electrocardiogram, and any combination of voice, face, finger, iris, palm, signature, vascular, and electrocardiogram. Moreover, biometric data may take any form such as, but not limited to, audio recordings, photographic images, and video streams. Authentication data may be identifying information associated with any hardware authentication device that communicates with the AC system 16 during authentication transactions, for example, the communications device 12.

The enrollment data record of each authorized individual stored in the AC system 16 includes authentication data such as, but not limited to, enrollment biometric data, enrollment biometric templates, personal data of the individual, and a unique identifier of the individual. The enrollment biometric data is raw biometric data captured from the individual during enrollment in the AC system 16. The enrollment biometric data for each individual is processed during enrollment to generate at least one enrollment biometric template, for each respective individual, which may be used by the AC system 16 to conduct authentication transactions. The enrollment biometric data itself may also be used by the AC system 16 to conduct authentication transactions. Personal data includes any biographic or demographic information regarding an individual including, but not limited to, an individual's name, gender, age, date-of-birth, address, citizenship, marital status, and data regarding the communications device 12 associated with the individual. Each enrollment data record may also include any kind of data that may be used to authenticate the identity of individuals as described herein. The data included in the enrollment data records may be captured directly from individuals during enrollment, or may be obtained by other methods including, but not limited to, automatically reading or extracting the data from identity documents or from legacy databases included in other systems (not shown). The enrollment data record of each individual may also include data associated with at least one authentication credential of the individual.

The CVS system 18 and the merchant system 20 include components such as, but not limited to, a web server, a database server, an application server, and a disk storage unit that may be used to store any kind of data. The CVS system 18 may store information regarding authentication credentials issued to individuals such as, but not limited to, the status of issued authentication credentials. The status of authentication credentials may be revoked, suspended, expired, or not expired. The CVS system 18 may also store the expiration date of each authentication credential for use in determining whether an authentication credential has or has not expired. Authentication credentials include, but are not limited to, smart cards and digital certificates. Although digital certificates are authentication credentials, digital certificates may be included in other authentication credentials such as smart cards. The merchant system 20 may conduct network-based commercial transactions with at least the communications device 12, other devices (not shown) and other systems (not shown)

The communications device 12, the computer 14, the AC system 16, the CVS system 18, and the merchant system 20, respectively, each include a processor (not shown) and a memory (not shown). It should be understood that, as used herein, the term processor is not limited to just those integrated circuits referred to in the art as a processor, but broadly refers to a computer, an application specific integrated circuit, and any other programmable circuit. It should be understood that the processors execute instructions, or computer programs, stored in the respective memories (not shown) of the communications device 12, the computer 14, the AC system 16, the CVS system 18, and the merchant system 20. The above examples are exemplary only, and are thus not intended to limit in any way the definition and/or meaning of the term “processor.”

The respective memories (not shown) in the communications device 12, the computer 14, the AC system 16, the CVS system 18, and the merchant system 20 can be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like.

Each of the memories (not shown) can be a computer-readable recording medium used to store data, respectively, in the communications device 12, the computer 14, the AC system 16, the CVS system 18, and the merchant system 20. Moreover, each of the respective memories (not shown) can be a computer-readable recording medium used to store computer programs or executable instructions that are executed, respectively, by the communications device 12, the computer 14, the AC system 16, the CVS system 18, and the merchant system 20. Furthermore, the memories (not shown) may include SIMs or any other medium from which a computing device can read computer programs or executable instructions. As used herein, the terms “computer program” and “application” are intended to encompass an executable program that exists permanently or temporarily on any computer-readable recordable medium that causes the computer or computer processor to execute the program and thus causes the computer to perform a function.

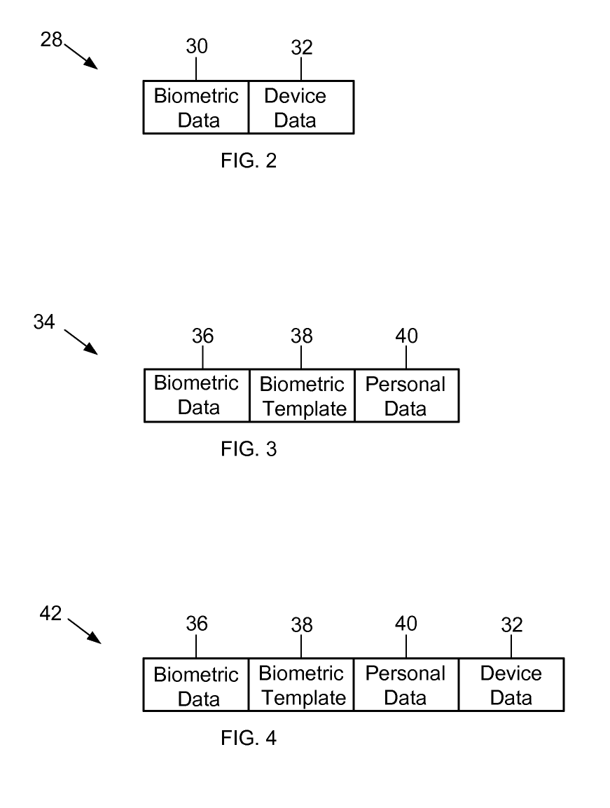

FIG. 2 is a diagram illustrating exemplary data 28 that may be stored in a first authentication credential issued to an authorized individual by an authorized entity. The first authentication credential is a smart card. Data 28 that may be stored in the first authentication credential includes, but is not limited to, biometric data 30 of the authorized individual and any type of device data 32 associated with the first authentication credential. Device data 32 is any type of data that may be associated with the first authentication credential. Device data 32 includes, but is not limited to, a serial number of an authentication credential, data associated with a hardware component of an authentication credential, data associated with a digital certificate included an authentication credential, and any combination thereof. Device data 32 may also include a digital certificate included in an authentication credential. A hardware component of an authentication credential may be, for example, a SIM card. A legitimate holder or user of an authentication credential is the authorized individual to whom the credential was issued by an authorized entity.

FIG. 3 is a diagram illustrating different exemplary data 34 that may be stored in a second authentication credential issued to an authorized individual. The second authentication credential is the enrollment data record of an authorized individual enrolled in the AC system 16. The second authentication credential includes, but is not limited to, biometric data 36, biometric template data 38, and personal data 40 of the individual. The biometric data 36 included in the second authentication credential is typically different than the biometric data 30 stored in the first authentication credential.

Although the first and second authentication credentials are a smart card and an enrollment data record, respectively, the first and second authentication credentials may alternatively be any authentication credential associated with the individual. For example, the first authentication credential may alternatively be an enrollment data record, a key fob, or a key stored in a computer system. The second authentication credential may also be a key fob, a key stored in a computer system, or a smart card. However, the first authentication credential is required to be different than the second authentication credential for each authentication transaction. Thus, for example, the first and second authentication credentials cannot both be a smart card during the same authentication transaction.

FIG. 4 is a diagram illustrating exemplary data 42 that may be stored in a third authentication credential derived from another authentication credential. Thus, the third authentication credential may also be referred to as a derived authentication credential. The derived authentication credential is a combination of data from the first and second credentials. More specifically, the derived authentication credential is the second credential combined with the device data 32 of the first authentication credential. The device data 32, as combined with the second authentication credential, functions as binding data.

Binding data establishes a highly trusted relationship between different authentication credentials that logically connects, or binds, the different authentication credentials to each other. Thus, the device data 32 included in the derived authentication credential logically connects, or binds, the first and second authentication credentials to each other. The nature of the highly trusted relationship is such that the derived authentication credential may be substituted for the first authentication credential during authentication transactions typically based on the first authentication credential.

It should be understood that any authentication credential of an individual may be combined with device data 32 from a different authentication credential of the same individual to create a derived authentication credential. The derived authentication credential may be substituted for the different authentication credential during authentication transactions typically based on the different authentication credential.

A credential authentication application stored in the communications device 12, the computer 14, or the AC system 16 is typically configured to process one type of authentication credential during authentication transactions, and thus may not be able to process different types of authentication credentials during authentication transactions. Consequently, before a different type of authentication credential, for example, a derived authentication credential can be substituted for another type of authentication credential, for example, a smart card, and be successfully processed by the credential authentication application, the credential authentication application may require modification in order to process the different type of authentication credential.

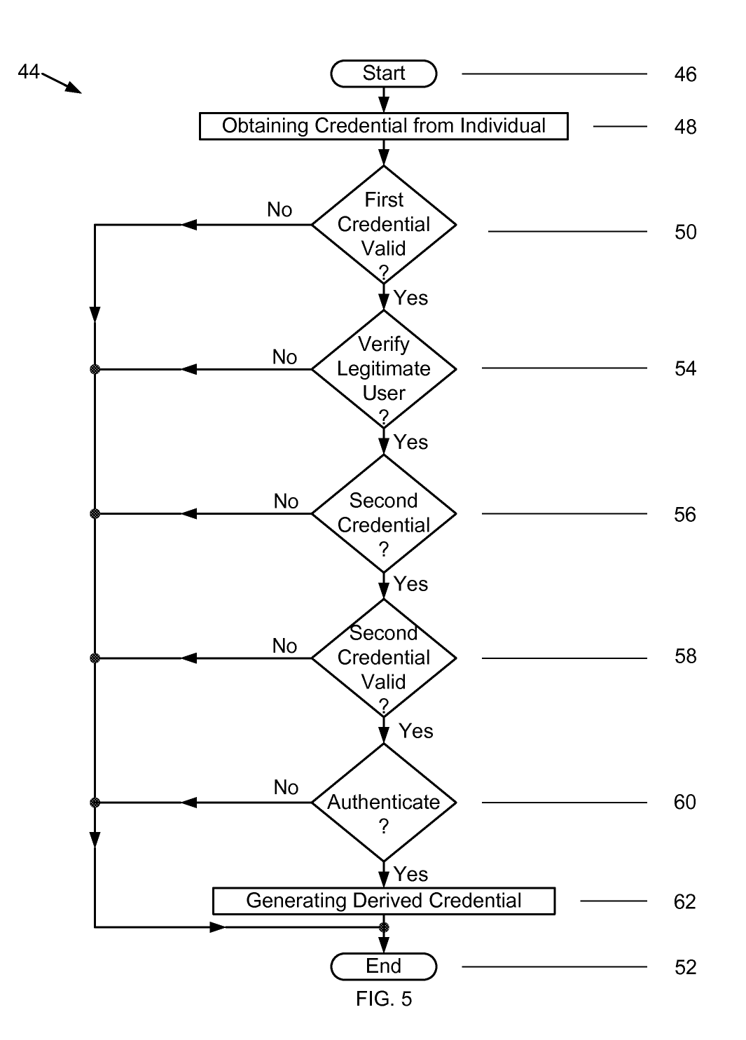

FIG. 5 is a flowchart 44 illustrating an exemplary process for generating derived authentication credentials used by the security system 10 for individuals enrolled in the AC system 16. For security system 10, the process starts 46 when security personnel of an authentication entity obtain an authentication credential 48 from an individual at an authentication station. The authentication credential is the first authentication credential as described herein with regard to FIG. 2. After obtaining the first authentication credential 48, the security personnel arrange for the computer 14 to read data 28 stored in the first authentication credential. The computer 14 continues processing by determining whether the first authentication credential is valid 50. More specifically, the computer 14 continues by verifying that the first authentication credential has not expired and that the data 28 included in the first authentication credential has not been improperly changed, and by validating the device data 32 included therein. In this exemplary process, the device data 32 is a digital certificate. Data included in an authentication credential is improperly changed when the change is made by an unauthorized entity.

When the first authentication credential has not expired and the data 28 therein has not been improperly changed, the computer 14 continues by transmitting the digital certificate to the CVS system 18. Next, the CVS system 18 continues by determining whether the received digital certificate is valid using cryptographic techniques. If the digital certificate is valid, the CVS system 18 continues by notifying the computer 14 that the digital certificate is valid. Otherwise, the CVS system 18 notifies the computer 14 that the digital certificate is not valid.

If the first authentication credential has expired, the data therein has been improperly changed, or the digital certificate is not valid, the first authentication credential is not valid 50. Next, the first authentication credential is returned to the individual and processing ends 52. However, when the first authentication credential has not expired, the data therein has not been improperly changed, and the digital certificate is valid, the first authentication credential is valid 50.

After determining the first authentication credential is valid 50, processing continues by verifying the individual is a legitimate user 54 of the first authentication credential. More specifically, processing continues by capturing authentication data from the individual with an authentication data capture device of the computer 14, and comparing the captured authentication data against corresponding authentication data included in the first authentication credential. The corresponding authentication data included in the first authentication credential may be the biometric data 30. When the captured and corresponding authentication data do not match, the individual is not successfully authenticated and may not be a legitimate user 54. Next, the first authentication credential is returned to the individual and processing ends 52. However, when the captured and corresponding authentication data match, the individual is successfully authenticated and is verified as a legitimate user 54 of the first authentication credential.

After successfully verifying that the individual is a legitimate user 54, the computer 14 continues by requesting the AC system 16 to determine whether a second authentication credential of the individual is stored therein 56. The second authentication credential is the second authentication credential as described herein with regard to FIG. 3. Specifically, the AC system 16 continues by searching the enrollment data records for a unique identifier of the individual. If the AC system 16 finds the unique identifier of the individual, a second authentication credential of the individual is stored therein. When the AC system 16 does not find the unique identifier of the individual, a second authentication credential is not stored 56 in the AC system 16. Next, the first authentication credential is returned to the individual and processing ends 52. However, when the AC system 16 finds the unique identifier of the individual a second authentication credential of the individual is stored 56 in the AC system 16. Next, the AC system 16 continues by verifying that the second authentication credential is valid 58. More specifically, the AC system 16 continues by confirming that identifying information regarding the communications device 12 of the individual is included in the second authentication credential 58, and that the second authentication credential has not expired 58. Identifying information includes, but is not limited to, a unique device identifier of the communications device 12.

When the second authentication credential does not include the identifying information or has expired, the second authentication credential is not valid 58. Next, processing continues by returning the first authentication credential to the individual, and processing ends 52. Otherwise, when the second authentication credential includes the identifying information and has not expired the second authentication credential is valid 58. After determining that the second authentication credential is valid 58, the AC system 16 initiates an authentication transaction 60 by transmitting an authentication data requirement to the device 12. The authentication data requirement requests capturing authentication data from the individual that corresponds to authentication data included in the second authentication credential. The authentication data requirement is for face biometric data. The authentication data requirement is for authentication data that is different than the authentication data included in the first authentication credential.

After receiving the authentication data requirement at the device 12, processing continues by capturing authentication data from the individual in accordance with the authentication data requirement. Next, the device 12 continues by transmitting the captured authentication data to the AC system 16, which continues by comparing the captured authentication data against corresponding authentication data included in the second authentication credential. When the captured and corresponding authentication data do not match, the individual is not successfully authenticated 60 and the AC system 16 continues by transmitting an unsuccessful authentication message to the computer 14. Next, the first authentication credential is returned to the individual and processing ends 52. However, when the captured and corresponding authentication data match the individual is successfully authenticated 60, and the AC system 16 continues by transmitting a successful authentication message to the computer 14.

In response to receiving the successful authentication message, the computer 14 continues by transmitting the device data 32 from the first authentication credential to the AC system 16. The device data 32 is the digital certificate of the first authentication credential. Next, the AC system 16 continues by generating a derived authentication credential 62. More specifically, the AC system 16 continues by combining the device data 32 with the second authentication credential to generate a derived authentication credential. After generating the derived authentication credential 62, the AC system 16 continues by storing the derived authentication credential therein and transmitting a message to the computer 14 indicating that a derived authentication credential was successfully generated for the individual. Next, the first authentication credential is returned to the individual and processing ends 52.

Although the device data 32 is a digital certificate in the exemplary generation process, in alternative processes the device data 32 may be a serial number of the first authentication credential, data associated with a hardware component of the first authentication credential, data associated with a digital certificate included in the first authentication credential, and any combination thereof. Although the AC system 16 confirms that the second authentication credential has not expired in operation 58 of the exemplary generation process, in alternative generation processes the AC system 16 may also determine whether the second authentication credential has been suspended or revoked. In such other alternative generation processes, the second authentication credential is valid 58 when it is not suspended, has not been revoked, and has not expired.

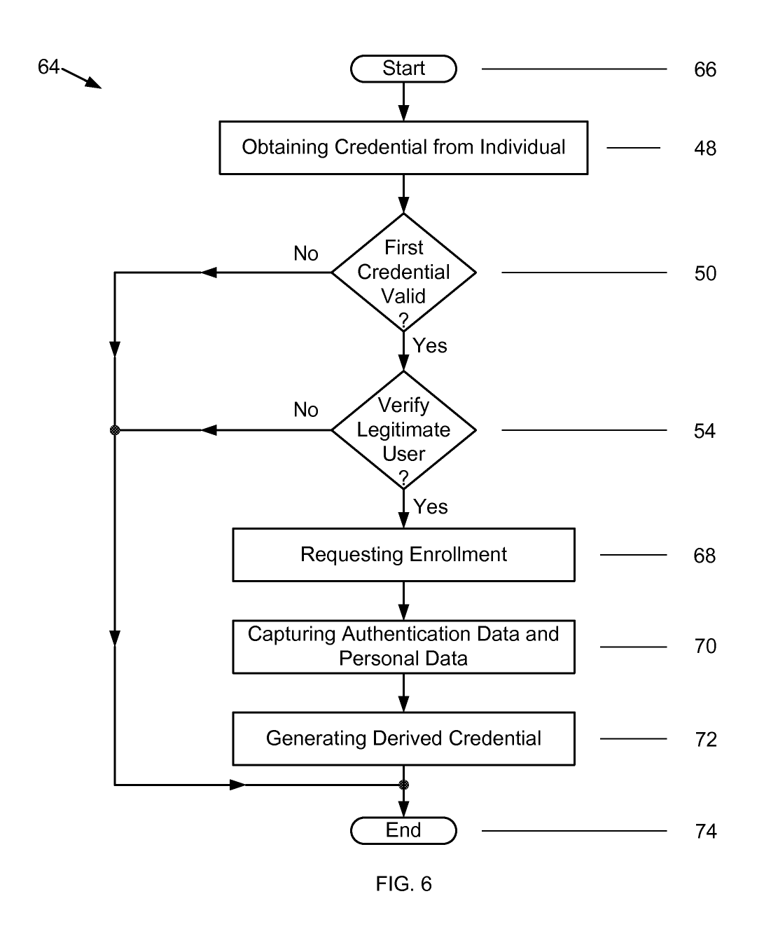

The information shown in FIG. 6 includes some of the same information shown in FIG. 5 as described in more detail below. As such, features illustrated in FIG. 6 that are identical to features illustrated in FIG. 5 are identified using the same reference numerals used in FIG. 5.

FIG. 6 is a flowchart 64 illustrating an exemplary process used by the security system 10 for generating a derived authentication credential for an individual not enrolled in the AC system 16. For security system 10, the process starts 66 by conducting operations 48, 50, and 54 in substantially the same manner as described herein in the exemplary generation process and as illustrated in FIG. 5. However, after verifying the individual is a legitimate user of the first authentication credential 54, the individual is enrolled in the AC system 16. More specifically, after verifying the individual is a legitimate user 54, the computer 14 continues by requesting 68 that the AC system 16 enroll the individual therein. In response, the AC system 16 continues by generating a message that includes data to be captured from the individual and transmitting the message to the device 12. The message data may include authentication data and personal data of the individual required for enrollment.

After receiving the message at the communications device 12, the individual continues by capturing 70 authentication data and personal data from his self in accordance with the message. The authentication data and personal data are captured with the communications device 12 and are transmitted to the AC system 16. Next, the AC system 16 continues by notifying the computer 14 that the authentication and personal data have been received. In response, the computer 14 continues by transmitting the device data 32 of the first authentication credential to the AC system 16.

The AC system 16 continues by generating a derived authentication credential 72 for the individual. More specifically, after receiving the captured authentication data, the personal data, and the device data 32, the AC system 16 continues by creating an enrollment data record for the individual that includes at least the captured authentication data, a biometric template, and personal data. The created enrollment data record is also the second authentication credential as described herein with regard to FIG. 3. Next, the AC system 16 continues by combining the created enrolment data record with the received device data 32 to thus generate a derived authentication credential 72. Next, the AC system 16 continues by transmitting a message to the computer 14 notifying security personnel that the individual has been successfully enrolled in the AC system 16 and that a derived authentication credential has been generated and issued for the individual. Next, processing ends 74.

Although the personal data is captured 70 with the communications device 12 in the exemplary alternative generation process, in other alternative generation processes the personal data may be captured from the individual with the computer 14. In such alternative processes, the AC system 16 notifies the computer 14 when the captured authentication data has been received. In response, the computer 14 continues by transmitting the captured personal data and the device data 32 of the first authentication credential to the AC system 16.

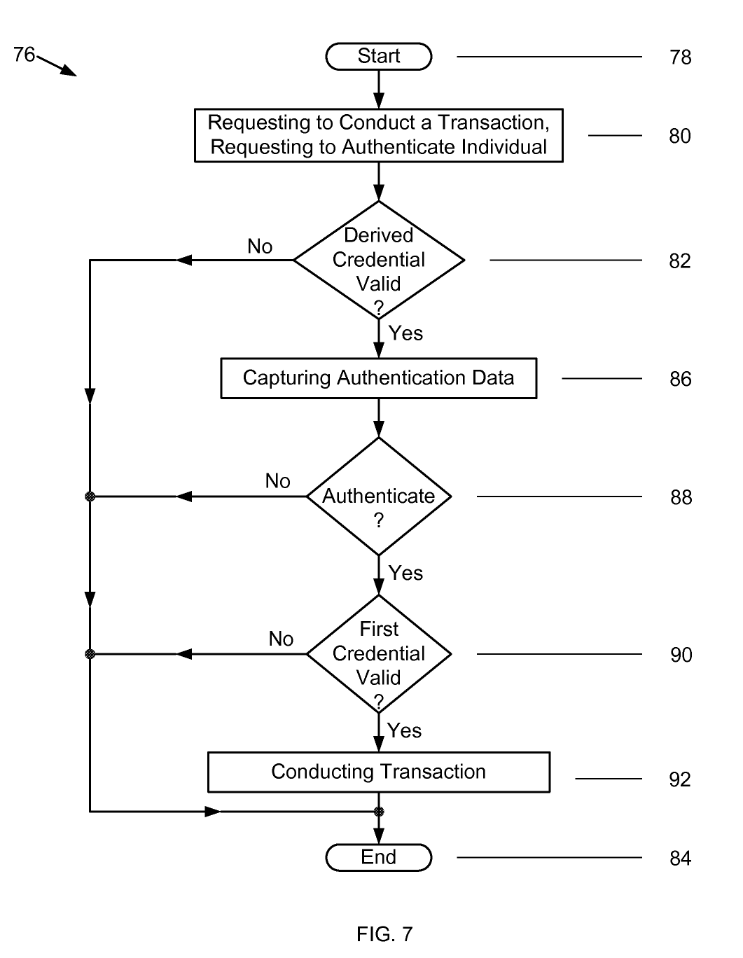

FIG. 7 is a flowchart 76 illustrating an exemplary authentication process used by the security system 10 for conducting authentication transactions with derived authentication credentials. For the security system 10, the process starts 78 when an individual operates his communications device 12 to view a merchant website operated by the merchant system 20, and continues by requesting to conduct a transaction 80. In this exemplary authentication process, the transaction is a network-based transaction for remotely purchasing a product from the merchant website over the network 22. However, the transaction may alternatively be any transaction requested by the individual, or any transaction that the individual may be involved in, that requires successfully authenticating the identity of the individual remotely via a network or in person without a network.

The merchant system 20 typically requires successfully authenticating the individual based on the first authentication credential of the individual before allowing the individual to conduct the transaction. However, in this exemplary authentication process the credential authentication application has been modified such that the derived authentication credential of the individual may be substituted for the first authentication credential of the individual. Thus, the individual uses his derived authentication credential to conduct the authentication transaction in this exemplary authentication process. The first authentication credential of the individual is as described herein with regard to FIG. 2 and the derived authentication credential of the individual is as described herein with regard to FIG. 4.

The merchant system 20 continues by requesting 80 that the AC system 16 authenticate the requesting individual. After receiving the authentication request, the AC system 16 continues by determining whether the derived authentication credential is valid 82. A derived authentication credential is valid if it is stored in the AC system 16, has not been revoked, and has not expired. More specifically, the AC system 16 continues by searching the derived authentication credentials stored therein for the unique identifier of the individual. When the AC system 16 finds the unique identifier of the individual, the derived authentication credential of the individual is stored therein; otherwise, not.

When the derived authentication credential is not stored in the AC system 16, the merchant system 20 is notified that the individual cannot be successfully authenticated and processing ends 84. When the derived authentication credential is stored in the AC system 16 but has been revoked or has expired, the merchant system is also notified that the individual cannot be successfully authenticated and processing ends 84. However, when the derived authentication credential is stored in the AC system 16, has not been revoked, and has not expired, the derived authentication credential is valid 82.

After determining that the derived credential is valid 82, the AC system 16 continues by determining an authentication data requirement for the transaction and transmitting the authentication data requirement to the communications device 12. The authentication data requirement is for face biometric data. The individual reads the authentication data requirement from the communications device 12 and continues by capturing authentication data 86 from his self with the communications device in accordance with the authentication data requirement. The communications device 12 continues by transmitting the captured authentication data to the AC system 16 which continues processing by authenticating the individual 88. More specifically, the AC system 16 continues by comparing the captured authentication data against corresponding authentication data included in the derived authentication credential. When the captured and corresponding authentication data do not match, the identity of the individual is not successfully authenticated 88. Next, processing continues by notifying the merchant system 20 that the individual cannot be properly authenticated and processing ends 84. However, when the captured and corresponding authentication data match, the identity of the individual is successfully authenticated 88.

After successfully authenticating the individual 88, the AC system 16 continues by determining whether or not the first authentication credential of the individual is valid 90. More specifically, the AC system 16 continues by transmitting the device data 32 included in the derived authentication credential to the CVS system 18 which continues by determining whether the received device data 32 corresponds to an authentication credential that has not expired and has not been revoked. If the received device data 32 corresponds to an expired or revoked authentication credential, the first authentication credential is invalid 90 and the CVS system 18 continues by notifying the AC system 16 that the first authentication credential is invalid. Next, the merchant system 20 is notified that the individual cannot be successfully authenticated and processing ends 84. However, when the received device data 32 corresponds to an authentication credential that has not expired and has not been revoked, the first authentication credential is valid 90 and the CVS system 18 continues by notifying the AC system 16 that the first authentication credential of the individual is valid.

After validating 90 the first authentication credential, the AC system 16 continues by notifying the merchant system 20 that the requesting individual has been successfully authenticated 88. Next, the merchant system 20 continues by permitting the individual to conduct the requested transaction 92. After conducting the transaction 92, processing ends 84.

Although the exemplary authentication process includes a single authentication operation 88, alternative authentication processes may include a plurality of authentication operations based on the same or different authentication data. Each of the plurality of authentication operations is conducted with a different authentication algorithm. The AC system 16 may dynamically select any combination of authentication algorithms for conducting an authentication transaction. For example, in such alternative processes the AC system 16 may dynamically select algorithms for conducting an authentication transaction based on biometric data followed by an authentication transaction based on the PIN of the individual. After successfully authenticating the individual in each of the different authentication transactions, the identity of the individual may be considered successfully authenticated.

Although the authentication data requirement is for face biometric data in the exemplary generation and authentication processes described herein, the authentication data requirement may alternatively be for any type of authentication data, or any combination of different types of authentication data.

In each embodiment, the above-described methods for generating derived authentication credentials and conducting authentication transactions with derived authentication credentials facilitate reducing authentication transaction costs and risks. More specifically, a first authentication credential obtained from an individual is evaluated to determine whether the obtained credential is valid. The first authentication credential includes device data. After determining the first authentication credential is valid, the authentication system verifies that the individual is a legitimate user of the first authentication credential. After determining that the individual is a legitimate user and determining that a second authentication credential associated with the individual is valid, authentication data is captured from the individual with a communications device. After successfully authenticating the individual with an authentication system using the captured authentication data, a derived authentication credential is generated by combining the second authentication credential with the device data.

The generated derived authentication credential of an individual may be substituted for a different authentication credential of the individual during authentication transactions typically based on the different authentication credential. After validating the derived authentication credential, the individual is authenticated against authentication data included in the derived authentication credential. After successfully authenticating the individual, the different authentication credential is evaluated for validity. After determining the different authentication credential is valid, the individual is permitted to conduct a requested transaction. As a result, the costs and risks associated with using authentication credentials that may be easily lost or stolen are facilitated to be reduced. Moreover, the security of authentication transactions based on such authentication credentials is facilitated to be enhanced in a cost effective and reliable manner.

Exemplary embodiments of systems and processes for generating derived authentication credentials and conducting authentication transactions with derived authentication credentials that reduce risks that imposters will gain access to confidential data are described above in detail. The systems and processes described above facilitate using many different types of authentication credentials to conduct authentication transactions with authentication systems. Such different authentication credentials include, but are not limited to, authentication credentials which support dynamic authentication method selection. Moreover, the systems and processes described above facilitate authenticating individuals when an authentication credential, such as a smart card, is not available, cannot be read, or cannot otherwise be accommodated during an authentication transaction. Furthermore, the systems and processes described above facilitate managing authentication credentials of an individual such that changes in the status of one authentication credential may automatically be made to related authentication credentials.

The processes are not limited to use with the specific computer system embodiments described herein, but rather, the processes can be utilized independently and separately from other processes described herein. Moreover, the invention is not limited to the embodiments of the systems and processes described above in detail. Rather, other variations of the processes may be utilized within the spirit and scope of the claims.

While the invention has been described in terms of various specific embodiments, those skilled in the art will recognize that the invention can be practiced with modification within the spirit and scope of the claims.

What is claimed is:

1. A method for generating a derived authentication credential comprising:
determining whether a first authentication credential obtained from an individual is valid, the first authentication credential including device data;
verifying the individual is a first authentication credential legitimate user after the first authentication credential is validated;
determining that a second authentication credential associated with the individual is valid after said verifying operation determines the individual is the legitimate user;
capturing authentication data from the individual with a communications device; and
after successfully authenticating the individual with an authentication computer system with the captured authentication data, combining the second authentication credential with the device data.

2. A method for generating a derived authentication credential in accordance with claim 1, said determining whether the first authentication credential is valid operation comprising:
verifying that the first authentication credential has not expired and that data included therein has not been changed; and
validating the digital certificate.

3. A method for generating a derived authentication credential in accordance with claim 2, said validating operation comprising determining whether the device data is valid with a credential validation server.

4. A method for generating a derived authentication credential in accordance with claim 2, said validating operation comprising determining whether information contained within the device data is valid with a credential validation server.

5. A method for generating a derived authentication credential in accordance with claim 1, said verifying operation comprising:
capturing authentication data from the individual;
comparing the captured authentication data against corresponding authentication data included in the first authentication credential; and
determining the individual is a first authentication credential legitimate user when the captured and corresponding authentication data match.

6. A method for generating a derived authentication credential in accordance with claim 1, said determining the second authentication credential is valid operation comprising:
confirming that the second authentication credential includes identifying information regarding the communications device; and
confirming that the second authentication credential has not expired and has not been revoked.

7. A system for generating a derived authentication credential comprising:
a communications device configured to capture authentication data, said device being associated with an individual;
a computer positioned at an authentication station, said computer being configured to determine whether a first authentication credential obtained from an individual has not expired and that data included in the first authentication credential has not been changed, the first authentication credential including device data;
a credential validation system configured to validate the device data; and
an authentication computer system comprising an authentication database, said authentication system, said credential validation system, said computer and said communications device being configured to communicate with each other over a network, said authentication system being further configured to
verify the individual is a first authentication credential legitimate user, and
combine a second authentication credential associated with the individual with the device data after verifying the individual is a legitimate user and successfully authenticating the individual.

8. A system for generating a derived authentication credential in accordance with claim 1, said communications device comprising:
a smart phone;
a tablet computer;
a laptop computer;
an entertainment device; or
a gaming console.

9. A system for generating a derived authentication credential in accordance with claim 1, said authentication system being further configured to determine an authentication data requirement, the authentication data requirement being at least one of:
biometric data;
a pass-phrase; and
geolocation coordinates.

10. A system for generating a derived authentication credential in accordance with claim 1, the device data including at least one of a serial number of the first authentication credential, a digital certificate of the first authentication credential, and information about the digital certificate.

11. A method for conducting an authentication transaction using a derived authentication credential comprising:
determining whether a derived authentication credential for an individual is valid with an authentication computer system, the derived authentication credential including an enrollment data record for the individual and binding data, the binding data being from a different authentication credential assigned to the individual;
authenticating the individual with the derived authentication credential when the derived authentication credential is valid;
after successfully authenticating the individual, determining whether the different authentication credential is valid with a credential validation system; and
conducting a desired transaction when the different authentication credential is valid.

12. A method for conducting an authentication transaction in accordance with claim 11, further comprising capturing authentication data from the individual after the individual requests to remotely conduct the desired transaction.

13. A method for conducting an authentication transaction in accordance with claim 12, said authenticating operation comprising comparing the captured authentication data against enrollment authentication data included in the enrollment data record.

14. A method for conducting an authentication transaction in accordance with claim 11, said determining whether the derived authentication credential is valid operation comprising:
determining the derived authentication credential is valid when the derived authentication credential is stored in the authentication computer system, has not been revoked, and has not expired; and
determining the derived authentication credential is invalid when the derived authentication credential is not stored in the authentication computer system, has been revoked, or has expired.

15. A method for conducting an authentication transaction in accordance with claim 11, further comprising:
capturing authentication data from the individual during enrollment in the authentication computer system;
comparing the captured authentication data against authentication data stored on the different authentication credential;
after determining that the captured authentication data and the different authentication credential authentication data match, capturing enrollment authentication data from the individual; and
creating the enrollment data record, the enrollment data record comprising the enrollment authentication data.

16. A method for conducting an authentication transaction in accordance with claim 11, said authenticating operation comprising:
dynamically selecting a plurality of authentication algorithms; and
conducting an authentication transaction with each algorithm, and successfully authenticating the individual after successfully conducting each authentication transaction.

17. A method for conducting an authentication transaction in accordance with claim 11, further comprising:
verifying the individual is a legitimate user of the different credential after the different authentication credential is validated, the different authentication credential includes binding data, the binding data includes at least information associated with a digital certificate;
capturing authentication data from the individual with a communications device after said verifying operation determines the individual is the legitimate user; and
after successfully authenticating the individual with the captured authentication data, combining the second authentication credential with the binding data to create the derived authentication credential.
